(19) United States
(12) Patent Application Publication
(10) Pub. No.: US 2026/0135885 A1
(43) Pub. Date: May 14, 2026

(54) IDENTITY VERIFICATION WORKFLOW COMPLIANCE MANAGEMENT

(71) Applicant: Onfido Ltd., London (GB)

(72) Inventors: Allen Evans, Milton Keynes (GB); Thomas Stevenson, London (GB); Kai Moseley, Great Haywood (GB)

(21) Appl. No.: 19/387,309

(22) Filed: Nov. 12, 2025

Related U.S. Application Data
(60) Provisional application No. 63/720,420, filed on Nov. 14, 2024.

(51) Int. Cl. H04L 9/40; G06Q 10/0633

(52) U.S. Cl. CPC H04L 63/20; G06Q 10/0633

(57) ABSTRACT

Identity verification workflow compliance management is provided. In example aspects, a workflow management engine evaluates a workflow configured by a user. The workflow management engine may determine a validity of the workflow and whether the workflow is compliant with selected compliance standards. In some embodiments, a user may edit a workflow through a workflow interface. As the user modifies the workflow, the workflow management engine may continually monitor the status of the workflow (i.e., whether the workflow is valid and compliant with the selected compliance standards). The workflow management engine may present indicators in the workflow interface indicating that the workflow is invalid or not compliant with the identified standards as the user makes modifications to the workflow.

### CROSS-REFERENCE TO RELATED APPLICATIONS

This application claims priority to U.S. Provisional Ser. No. 63/720,420 filed Nov. 14, 2024, the disclosure of which is hereby incorporated by reference in its entirety.

### BACKGROUND

Identity verification allows applications, data, and other secure content to be protected, blocking unauthorized users from accessing the secure content. To enable identity verification, an identity verification workflow may be created and executed when identity verification is required. In the context of an organizational entity, one or more users associated with that organization may need to create an identity verification workflow to enable access to the organization's secure content. However, those users may not have the requisite technical knowledge to implement an identity verification workflow or an appropriate understanding of how to determine if a workflow they wish to create is valid (e.g., free of syntax errors, logic flaws, misconfigured dependencies). Moreover, users may not have sufficient knowledge to determine whether a workflow complies with applicable compliance standards in particular jurisdictions, as requirements for identity verification processes, security and data retention processes, and the like, may vary.

### SUMMARY

In accordance with aspects of the present disclosure, identity verification workflow compliance management is provided. In example aspects, a workflow is built and evaluated (e.g., in real-time) to determine whether the workflow is valid and compliant. A workflow may be valid if the required inputs and configurations are provided to the workflow and to each task in the workflow. Other rules may additionally or alternatively be considered when determining the validity of a workflow. For example, each branch of the workflow may be required to end with a node associated with a validation outcome. A workflow may be compliant if the workflow meets the requirements dictated by one or more selected compliance standards. The workflow may be evaluated for validity and/or compliance each time the workflow is modified. For example, a user can receive dynamic feedback, such as a notification of an invalid or noncompliant identity verification task, while editing the workflow.

In a first aspect, a method for managing identity verification workflow compliance is provided. A selection of one or more compliance standards is received. The one or more compliance standards are associated with a workflow rule. A workflow is presented at a workflow interface. The workflow includes one or more tasks executed during the workflow. A workflow edit input defining a change to the workflow is received at the workflow interface. In response to receiving the workflow edit input, a status of the workflow is determined. The status of the workflow includes a compliance of the workflow with the workflow rule. A workflow status indicator is presented at the workflow interface based on the determined status of the workflow.

In a second aspect, a system for managing identity verification workflow compliance is provided. The system includes one or more processors and one or more computer-readable storage devices storing data instructions. Execution of the data instructions by the one or more processors causes the system to receive a selection of one or more compliance standards, present a workflow at a workflow interface, receive a workflow edit input defining a change to the workflow at the workflow interface, determine a status of the workflow in response to receiving the workflow edit input, and present a workflow status indicator based on the determined status of the workflow at the workflow interface. The one or more compliance standards are associated with a workflow rule. The workflow includes one or more tasks performed during execution of the workflow. The status of the workflow includes a compliance of the workflow with the workflow rule.

In a third aspect, a non-transitory computer-readable medium is provided. The non-transitory computer-readable medium has stored thereon data instructions that, when executed by one or more processors, cause the one or more processors to receive a selection of one or more compliance standards, present a workflow at a workflow interface, receive a workflow edit input defining a change to the workflow at the workflow interface, determine a status of the workflow in response to receiving the workflow edit input, and present a workflow status indicator based on the determined status of the workflow at the workflow interface. The one or more compliance standards are associated with a workflow rule. The workflow includes one or more tasks performed during execution of the workflow. The status of the workflow includes a compliance of the workflow with the workflow rule.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment in which an identity verification workflow may be used.

FIG. 2 illustrates an embodiment of a system for creating and modifying an identity verification workflow.

FIG. 3 illustrates an example of a new workflow interface.

FIG. 4 illustrates an example workflow interface.

FIG. 5 illustrates an example workflow interface.

FIG. 6 illustrates an example workflow interface.

FIG. 7 illustrates an example workflow interface.

FIG. 8 illustrates an example workflow interface.

FIG. 9 illustrates an example workflow interface.

FIG. 10 illustrates an example workflow interface.

FIG. 11 illustrates an example workflow interface.

FIG. 12 illustrates an example workflow interface.

FIG. 13 illustrates an example data structure of compliance standards maintained within a database, according to an embodiment.

FIG. 14 illustrates a flowchart of an example method for managing identity verification workflow compliance.

FIG. 15 illustrates a block diagram of an embodiment of a computing device on which aspects of the present disclosure may be implemented.

### DETAILED DESCRIPTION

In accordance with aspects of the present disclosure, dynamic management of identity verification workflow compliance is provided. In example aspects, a workflow management engine evaluates a workflow (e.g., an identity verification workflow) configured by a user. The workflow management engine may determine whether the workflow is valid and compliant. In examples, the workflow management engine may determine a validity of the workflow and a compliance of the workflow based on identified standard(s).

In some embodiments, validity of a workflow is determined based on evaluation of one or more of: syntax, processing logic, dependency management, data compatibility, error handling, access permissions, or resource availability. In an example, a workflow may be determined to be invalid if a required library, API, or external resource is referenced but inaccessible. In an example, a workflow is valid if, for each task in the workflow, all required inputs and configurations are provided and handling logic for exit conditions are specified. In another example, to be valid, each branch of the workflow may be required to end with a node associated with a validation outcome.

In some embodiments, compliance of a workflow is determined based on comparison of workflow element(s) to rule(s) of a compliance standard. A compliance standard can, for example, include rules related to one or more of the following: data security, data retention, privacy regulations, auditability, or access control. In an example, a workflow is compliant with an identified compliance standard if the workflow satisfies every rule required by the standard.

In some embodiments, a user may edit a workflow through a workflow interface. For example, the user may add, remove, or modify tasks of a workflow. As the user customizes the workflow, the workflow management engine may continually monitor the status of the workflow (e.g., whether the workflow is valid and/or compliant with an identified standard). The workflow management engine may present indicators in the workflow interface indicating whether the workflow is valid and compliant with the identified standards as the user makes modifications to the workflow. Because the indicators are presented to the user as the user is designing the workflow, the user can quickly determine what changes are necessary to make the workflow valid and compliant.

In some implementations, the workflow management engine causes the workflow interface to display a suggestion to the user. For example, the suggestion can include an edit (e.g., addition, removal, or modification of a workflow element) that would improve the validity or compliance of the workflow. In an example, the suggestion includes an indication of the underlying condition to be corrected. For example, the suggestion can include the rule of an identified compliance standard that is unsatisfied.

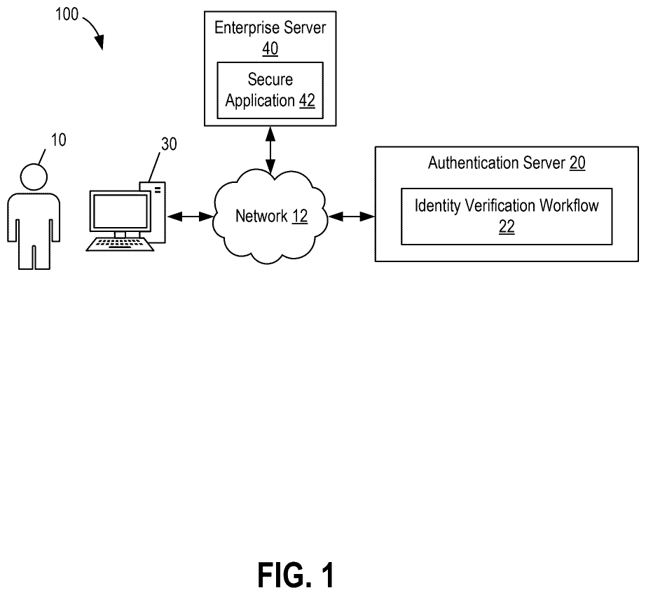

Referring to FIG. 1, an example system 100 for generation and implementation of an identity verification workflow is provided. In the illustrated example, a user 10 may attempt to access a secure application 42 on an enterprise server 40 through a computing device 30.

Computing device 30 comprises an electronic device in communication with system 100. For example, the computing device 30 may be connected to the enterprise server 40 over a network 12, such as the Internet. In an example, computing device 30 can be desktop computer, a laptop computer, tablet, mobile computing device, server, workstation, or Internet-of-things (IoT) device, among other electronic devices. Though depicted as a single computing device, system 100 can, in other embodiments, include a plurality of computing devices 30, such as a networked system of devices, accessible by one or more users.

In an embodiment, as illustrated in FIG. 1, authentication server 20 and enterprise server 40 are each implemented on a single device, having their own processor and memory. In embodiments, system 100 can be a cloud-based service such that customization and execution of identity verification workflows can be distributed across a network of multiple computing devices (e.g., with each device having its own processor and memory).

In an embodiment, access to the secure application 42 is controlled based on user verification. An authentication server 20 may verify the identity of the user 10 by executing an identity verification workflow 22. For example, the identity verification workflow 22 may include one or more tasks to authenticate the user 10, such as multi-factor authentication, re-authentication, document verification, and biometric authentication. After the identity of the user 10 is verified, the user 10 may be granted access to the secure application 42.

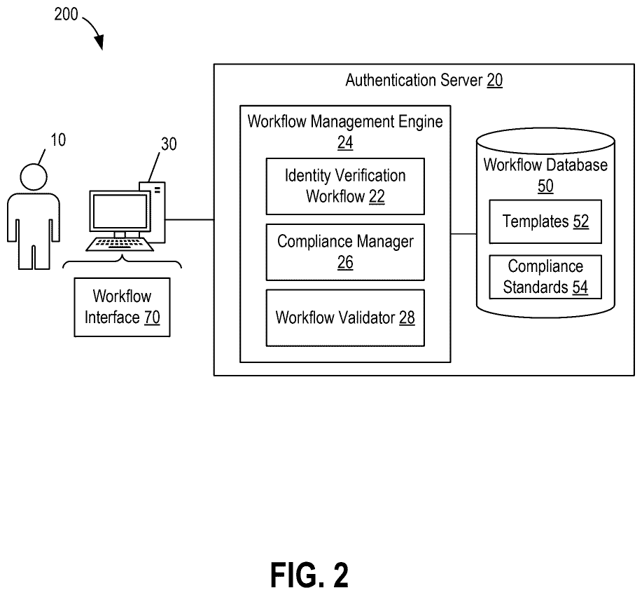

FIG. 2 illustrates an example system 200 for creating and modifying an identity verification workflow. In the illustrated embodiment, the system 200 includes an authentication server 20 and a computing device 30. In embodiments, the authentication server 20 includes a workflow management engine 24 and a workflow database 50. In an example, the computing device 30 may be connected to the authentication server 20 over a network, as described above.

In an embodiment, a user 10 may build or modify an identity verification workflow 22 through a workflow interface 70 presented on the computing device 30. As described further herein, when initially creating the identity verification workflow 22, the user 10 may select to build the workflow 22 from scratch or may select from among one or more templates 52 defining predesigned workflows. In examples, the templates 52 may include workflows configured for defined use cases. The templates 52 may additionally or alternatively include workflows configured to meet compliance standards in one or more jurisdictions.

Workflow interface 70 provides input/output capabilities of authentication server 20. In an embodiment, workflow interface 70 is a graphical user interface, configured to display workflow elements and receive user input related to workflow management engine 24. For example, a user can add an identity verification task to a workflow through workflow interface 70. For example, workflow interface 70 can present notifications to a user relating to the performance (e.g., efficiency), validity, and/or compliance of a workflow generated through workflow management engine 24.

In an embodiment, workflow interface 70 integrates with workflow database 50 to access data, trigger events, and exchange information. In an example, authentication server 20 provides one or more APIs or connection protocols to allow workflow interface 70 to exchange data with external platforms or services (not shown).

In the illustrated embodiment, workflow database 50 is a storage repository configured to store templates 52 and compliance standards 54. In an embodiment, workflow database 50 can be a general-purpose database management storage system (DBMS) or relational DBMS as implemented by, for example, ORACLE, IBM DB2, Microsoft SQL Server, PostgreSQL, MySQL, SQLite, LINUX, or UNIX solutions. In an embodiment, workflow database 50 can be external to authentication server 20, such as stored in memory of computing device 30 or located on a different server.

Workflow management engine 24 is configured to allow the user 10 to generate or modify an identity verification workflow 22. To facilitate dynamic customization by the user 10, workflow management engine 24 includes predefined authentication tasks, such as multi-factor authentication, re-authentication, document verification, and biometric authentication. In an embodiment, authentication tasks include one or more routines (e.g., workflow properties, triggers, and/or actions associated with an identity verification measure) that are customizable. Workflow management engine 24 allows the user 10 to incorporate desired authentication tasks into identify verification workflow 22 without programming expertise.

As the user 10 builds or modifies the identity verification workflow 22, the workflow management engine 24 can monitor a status of the identity verification workflow 22. For example, the workflow management engine 24 may determine whether the identity verification workflow 22 is valid—e.g., whether each task in the identity verification workflow 22 receives the proper inputs and configurations to operate correctly. In an embodiment, the workflow management engine 24 may include a workflow validator 28 that tracks a validity of the identity verification workflow 22. The workflow validator 28 can be presented to the user 10 via workflow interface 70.

In an embodiment, the workflow validator 28 determines the validity of the identity verification workflow by analyzing the identity verification workflow 22 as a directed graph. For example, the workflow validator 28 may begin at an initial task of the identity verification workflow 22 and traverse through the identity verification workflow 22 to each end state of the identity verification workflow 22. As the workflow validator 28 traverses the identity verification workflow 22, if the workflow validator 28 encounters a task that requires an input that was not an output of a previous task or that is inaccessible, the workflow validator 28 may determine that the identity verification workflow 22 is invalid. For example, the workflow validator may determine that the user 10 or the workflow management engine 24 lacks permission to access an input, for example, if a proper link to an external data source has not been established. The workflow 22 may also be invalid if a task includes an invalid or unfulfilled configuration. For example, the workflow 22 may be invalid if a document capture task includes an empty list of supported documents. Conversely, if the workflow validator 28 traverses the identity verification workflow 22 and does not encounter a task that requires an input that was not an output of a previous task or has a configuration issue, the workflow validator 28 may determine that the identity verification workflow 22 is valid.

In some embodiments, the workflow validator 28 can analyze the identity verification workflow 22 beginning at an end state of the identity verification workflow 22 and traverse the identity verification workflow 22 backwards to determine that each task in the identity verification workflow 22 has the required inputs.

In some embodiments, the workflow validator 28 can conduct code analysis to determine whether a protocol would fail to run. For example, workflow validator 28 can determine whether an end condition associated with the identity verification workflow 22 is unobtainable or unspecified (e.g., whether a condition of an authentication task will never terminate based on an input).

The workflow management engine 24 may additionally or alternatively determine whether the identity verification workflow 22 is compliant with one or more standards. Governments and organizations may set standards for identity verification processes. Relevant standards for a particular identity verification workflow may depend on, for example, jurisdiction, industry, or used technology. For example, the National Institute of Standards and Technology (NIST) may set standards in the United States, whereas the European Telecommunications Standards Institute (ETSI) may provide standards that are adopted in European jurisdictions. In the example illustrated in FIG. 2, the workflow management engine 24 includes a compliance manager 26 that determines whether the identity verification workflow 22 complies with selected standards.

In some embodiments, the workflow database 50 may include one or more compliance standards 54. The user 10 may select one or more standards against which the identity verification workflow 22 is compared. For example, if the user 10 intends the identity verification workflow 22 to execute in the United States, the user 10 may select for the identity verification workflow 22 to be compared against NIST standards. In some embodiments, rather than select specific compliance standards 54, the user 10 may identify jurisdictions or industries in which the identity verification workflow will be executed, and the compliance manager 26 can automatically determine the compliance standards 54 that apply in the selected jurisdictions.

The compliance manager 26 may evaluate the identity verification workflow 22 by traversing the identity verification workflow as a directed graph (e.g., similar to the workflow validator 28). As the compliance manager 26 traverses through each task of the identity verification workflow 22, the compliance manager 26 determines whether any of the tasks conflicts with the selected compliance standards 54. The compliance manager 26 can (e.g., also) determine whether a task required by the compliance standards 54 is missing. If any of the tasks conflict with the compliance standards 54 or if a task required by the compliance standards 54 is missing, the compliance manager 26 may determine that the identity verification workflow 22 is noncompliant. Conversely, if no tasks conflict with the compliance standards 54 and no tasks required by the compliance standards 54 are missing, the compliance manager 26 may determine that the identity verification workflow 22 is compliant.

Due to variations in standards across jurisdictions and the complexity of compliance standards 54, the user 10 may find it challenging to understand the requirements for the identity verification workflow 22. By using the compliance manager 26 to monitor the identity verification workflow 22, the user 10 can easily determine whether the identity verification workflow 22 meets the desired compliance standards 54.

In some embodiments, the compliance manager 26 can evaluate the compliance of multiple standards independently. For example, if two standards are determined by the compliance manager 26 to be relevant, the compliance manager 26 can provide separate indications of compliance for each standard. This segmentation allows the user 10 to appreciate differences in requisite security measures between standards.

In some embodiments, the compliance manager 26 consolidates multiple standards to a single rule set. Consolidation can streamline compliance by providing a single reference point, reducing redundancy, and saving time and resources in implementation and auditing. This unified approach enhances consistency, minimizing the risk of gaps that can arise from interpreting multiple standards, and simplifies auditing by allowing checks against one standard.

In some embodiments, the compliance manager 26 can dynamically update rules as standards and regulations evolve. Standard bodies often recognize and adopt developments from other standards bodies, leading to commonalities. By adapting changes on a rule-basis, developments to the verification process can be efficiently imported across standards.

Traditional compliance checks are often carried out on individual components in isolation, making it difficult to verify compliance of interdependent processes occurring across discrete components. For example, security protocols might be deployed across environments (e.g., cloud, on-premises, mobile), and each environment may have unique constraints affecting compliance. Navigating these requirements adds administrative and procedural complexity beyond the technical aspects of compliance.

Embodiments of the compliance manager 26 address this issue by centralizing the workflow process and abstracting compliance assessment (e.g., through a directed graph approach). Modeling relationships between inputs and outputs of identity verification tasks allows for consideration of data flow and task dependencies irrespective of implementing architecture. Moreover, paths within constructed graphs can be efficiently searched to detect cycles and identify efficiency improvements. The compliance manager 26 accordingly provides for consistent evaluation of rule sets within a comprehensive view of the system.

In an embodiment, when the identity verification workflow 22 is compliant and valid, the user 10 may elect to activate the identity verification workflow 22. In some embodiments, the workflow management engine 24 may prevent the user 10 from activating an identity verification workflow 22 that is not both compliant and valid. In other embodiments, the workflow management engine 24 may allow the user 10 to activate any valid identity verification workflow 22, even if the identity verification workflow 22 is not compliant (e.g., with a selected standard). In some embodiments, the workflow management engine 24 can suggest modifications to an existing workflow that would result in compliance with additional (e.g., unselected) standards.

While the above example shows the workflow management engine 24 operating on the authentication server 20, in alternative examples, the workflow management engine 24 may operate on the computing device 30. Similarly, while the templates 52 and the compliance standards 54 are shown in the database 50 on the authentication server 20, in alternative embodiments, some or all of the data associated with the templates 52 and compliance standards 54 may be maintained on the computing device 30. In an example, the user 10 may select compliance standards 54 to be applied to an identity verification workflow 22 being built by the user 10. In this example, the compliance standards 54 selected by the user 10 may be downloaded to the computing device 30, allowing the workflow management engine 24 to operate on the computing device 30 and determine if the identity verification workflow 22 is compliant.

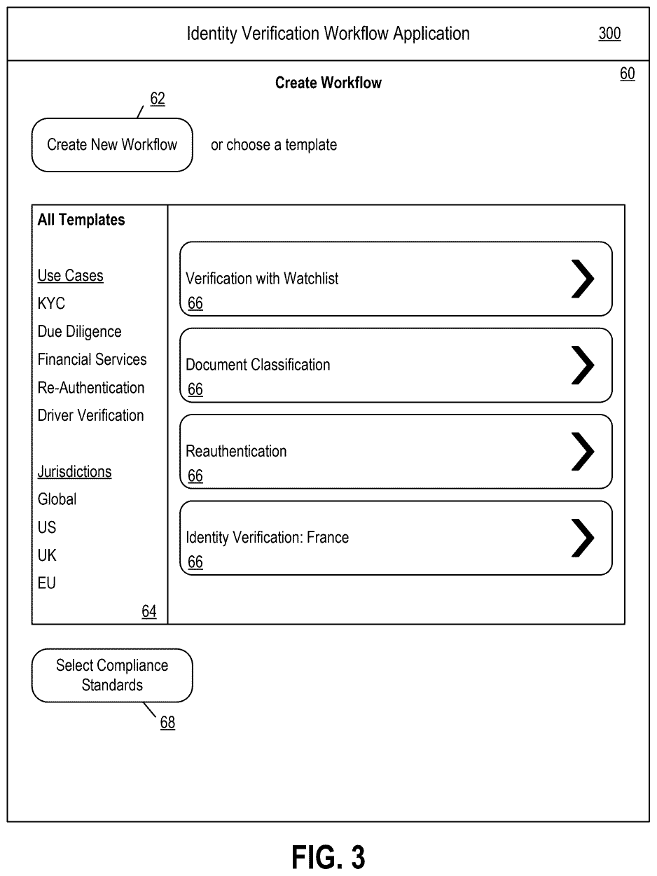

FIGS. 3-12 illustrate example interfaces through which a user may build or modify an identity verification workflow. As described above, the interfaces may be presented on a user computing device, such as computing device 30 described above in connection with FIG. 2. In some examples, the computing device may be connected to an authentication server, such as authentication server 20 described above in connection with FIG. 2, over a network. In examples, the interfaces are presented in an identity verification workflow application 300. In alternative examples, the interfaces may be presented in a browser.

FIG. 3 illustrates an example new workflow interface 60. In examples, a user may interact with the new workflow interface 60 to begin creation of a new workflow. In the illustrated example, the new workflow interface 60 includes an option 62 for a user to create a new workflow. For example, the option 62 may allow a user to create a workflow from scratch.

The new workflow interface 60 may additionally include options for a user to select a template 66 that includes a predefined workflow. Because some users may not fully understand the complexities of what is required for various workflows, the templates 66 allow users to quickly and easily create a workflow that is preconfigured to be valid. The templates 66 may (e.g., also) be preconfigured to be compliant with various standards, allowing users to quickly and easily create a compliant workflow without needing to fully understand the complexities of the rules defined by the standards.

In examples, the templates 66 may be configured to include workflows for specific use cases. In further examples, the templates 66 may be configured to include workflows that are compliant with standards defined in various jurisdictions. In the illustrated example, the new workflow interface 60 may include filters 64 with which a user may filter the templates 66 to see the templates 66 that apply to a selected use case or jurisdiction. In alternative examples, templates 66 may be configured for additional or alternative criteria, and the filters 64 may allow a user to filter the templates 66 based on the additional or alternative criteria.

In the illustrated embodiment, the new workflow interface 60 may additionally include an option 68 to select compliance standards against which the workflow will be evaluated. In an example, the user may select specific compliance standards. In an alternative example, the user may select one or more jurisdictions in which the workflow will be executed, and the compliance standards applied in the selected jurisdictions may automatically be determined.

In some embodiments, templates are dynamically presented to a user based on selected standards. For example, the identity verification workflow application 300 can include a set of templates for an identity verification process associated with a biometric token. The identity verification workflow application can then present a user with a template from the set of templates based on the rule set associated with the selected standard(s). In some embodiments, a standard can be selected implicitly based on an association with a selected jurisdiction, industry, or use case, such that the implicit standard is used in template selection.

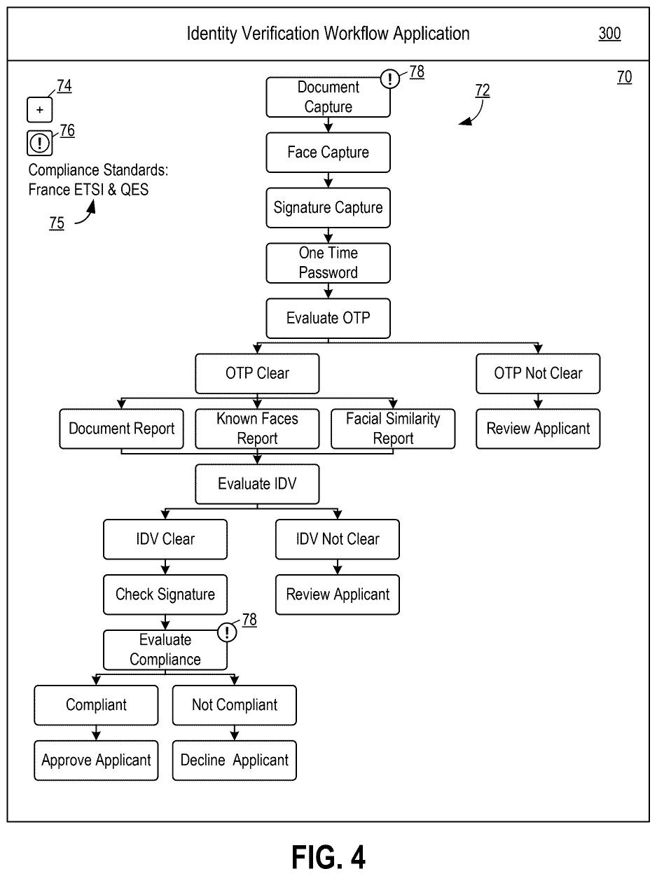

FIGS. 4-12 illustrate workflow interfaces 70 as a user builds a workflow. As the user makes changes to a workflow, a status of the workflow may be monitored to determine whether the workflow is valid and compliant. For example, with each change made by the user, the workflow may be evaluated to determine whether the workflow is valid and compliant. In embodiments, as described above, a workflow management engine including a compliance manager and a workflow validator may determine the status of the workflow.

In the illustrated examples, the workflow interface 70 includes a workflow 72 that includes one or more tasks performed during the workflow 72. In the illustrated example, the workflow 72 may include an identity verification workflow. In alternative examples, the workflow 72 may include additional or alternative workflows. Similarly, while the workflow 72 shown in the illustrated examples includes example tasks for an identity verification workflow, the workflow 72 is not limited to the tasks illustrated in the examples of FIGS. 4-12; in alternative embodiments, the workflow 72 may include additional or alternative tasks.

The workflow interface 70 may additionally include an option 74 to add an additional task to the workflow 72. In examples, a user may select a task from a list of tasks to add to the workflow 72. The user may control the placement of the task in a drag-and-drop manner, placing the task into the workflow 72 at the intended position. The user may additionally control which tasks lead into the newly added task and which tasks follow the newly added task in the workflow 72.

The workflow interface 70 may further include a workflow status indicator 76. The workflow status indicator 76 may present a determined status of the workflow 72. For example, if the workflow 72 is invalid or noncompliant, the workflow status indicator 76 may include an indication that there is an error in the workflow 72 that should be corrected. The indication can include a reference to the workflow routine that is determined to be in error. For example, if an input of a workflow task is determined to be incorrect, the edge of the directed graph leading to the workflow task can be highlighted. Conversely, if the workflow 72 is valid and compliant, the workflow status indicator 76 may indicate that the workflow 72 is in an appropriate condition to be activated.

If the workflow 72 includes conditions that make the workflow invalid or noncompliant, the workflow interface 70 may include task status indicators 78 that indicate which tasks in the workflow 72 include errors. The task status indicators 78 may be presented on the tasks that include errors, allowing the user to quickly identify which tasks need to be modified to make the workflow 72 valid and compliant.

In embodiments, the compliance standards against which the workflow 72 is evaluated are presented in the workflow interface 70 in a listing 75 of compliance standards. In some embodiments, the user may change which compliance standards are applied by selecting the listing 75 and modifying which compliance standards are selected. In the illustrated example, the compliance standards included in the list included compliance standards applied in France, including ETSI standards and qualified electronic signature (QES) standards. In an embodiment, the compliance standards that are applied to the workflow 72 may be determined based on tasks included in the workflow 72. For example, in the illustrated workflow 72, the workflow 72 includes an Evaluate Compliance task. In some examples, the Evaluate Compliance task may be associated with one or more compliance standards, so the compliance standards against which the workflow 72 is evaluated may include the compliance standards associated with the Evaluate Compliance task.

FIG. 4 illustrates a first example workflow interface 70. As described above, the workflow interface 70 includes a workflow 72 for identity verification including one or more tasks. As shown in the illustrated example, the workflow 72 may be noncompliant. In the illustrated example, a workflow status indicator 76 indicates that there are one or more errors in the workflow 72. The workflow interface 70 also includes task status indicators 78 on two of the tasks in the workflow 72 include errors: the Document Capture task and the Evaluate Compliance task. By checking the workflow status indicator 76 and the task status indicators 78, a user can quickly identify the errors in the workflow 72.

While the illustrated example indicates that the Document Capture task and the Evaluate Compliance task include errors affecting whether the workflow 72 is valid and compliant, in alternative examples, additional or alternative tasks may include errors that may affect validity and compliance.

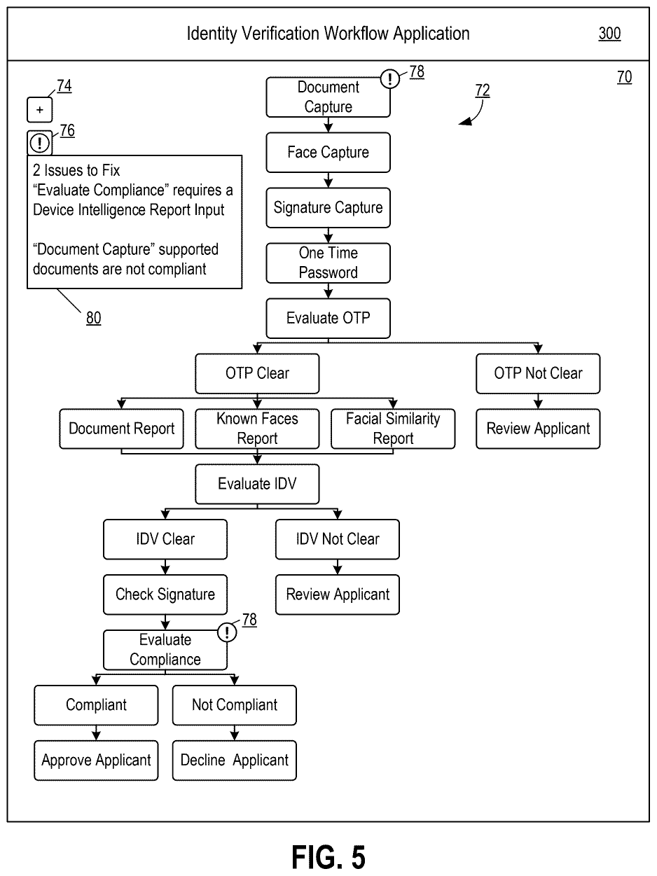

In embodiments, the workflow interface 70 may present additional details regarding the issues with validity and compliance when the user selects the workflow status indicator 76. FIG. 5 illustrates a second example of a workflow interface 70 presenting additional details associated with a status of the workflow 72.

When the user selects the workflow status indicator 76, such as by clicking on the workflow status indicator 76 or by hovering a cursor over the workflow status indicator 76, the workflow interface may present a workflow status window 80 presenting additional details associated with the status of the workflow 72. In the illustrated example, the workflow status window 80 includes a listing of the number of issues in the workflow 72 as well as a brief description of the issues. The workflow status window 80 may additionally indicate which tasks in the workflow 72 include the issues.

In the illustrated example, the user selected for the workflow 72 to be compliant in France—e.g., the workflow 72 is evaluated to determine if the workflow 72 meets ETSI standards and QES standards adopted in France. In this example, the workflow status window 80 indicates that the Evaluate Compliance task has an issue because the Evaluate Compliance task requires a Device Intelligence Report input that is not included in the workflow 72, as required by the selected compliance standards. Additionally, the workflow status window 80 indicates that the Document Capture task is configured to accept documents that are not compliant with the selected compliance standards.

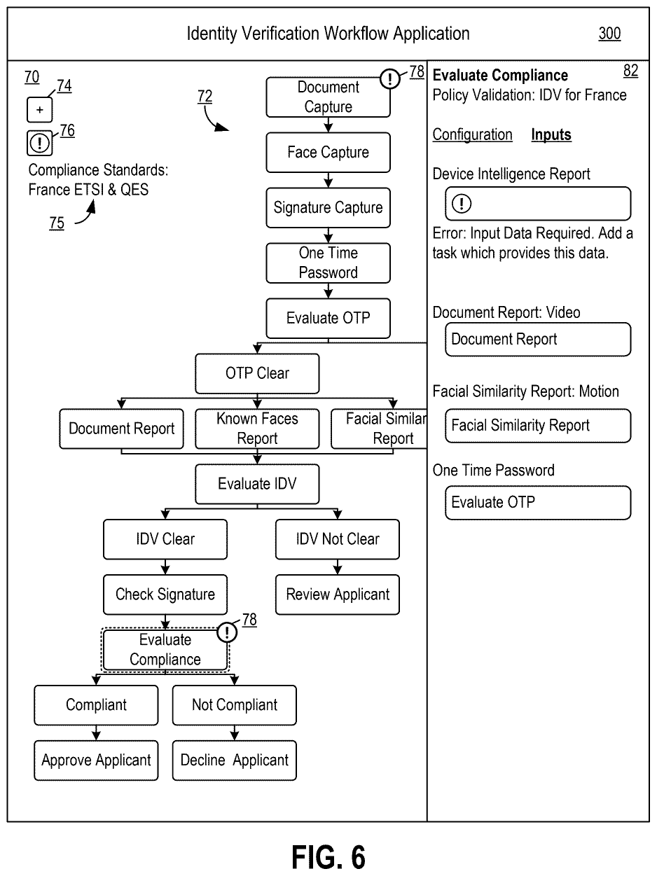

Once the user has identified the tasks that need to be modified to meet compliance standards, the user may select the tasks to modify aspects of the tasks. FIG. 6 illustrates a third example workflow interface 70 in which the user has selected a task to edit. In the illustrated example, the user selected the Evaluate Compliance task (e.g., by clicking on the Evaluate Compliance task in the workflow 72). When the Evaluate Compliance task is selected, the workflow interface 70 may present a task configuration interface 82 through which the user may modify aspects of the selected task.

In the illustrated embodiment, the task configuration interface 82 presents options for the user to modify the Evaluate Compliance task. In examples, the task configuration interface 82 includes options to change a configuration of the task and inputs of the task. The task configuration interface 82 may additionally indicate the compliance standards against which the workflow 72 is being compared.

As described above, in this example, the Evaluate Compliance task may include an issue because an input required by the selected compliance standards—i.e., a device intelligence report—is not included in the task. The task configuration interface 82 may present a list of the inputs of the task and show that a device intelligence report input has not been included in the workflow 72. The task configuration interface 82 may also present a brief description of the error with the task.

When the user modifies the workflow 72 to include the device intelligence report required by the selected compliance standards, the workflow 72 may be reevaluated to determine whether the workflow 72 is valid and compliant. As described above, the workflow 72 may be reevaluated each time the user makes a change to the workflow 72.

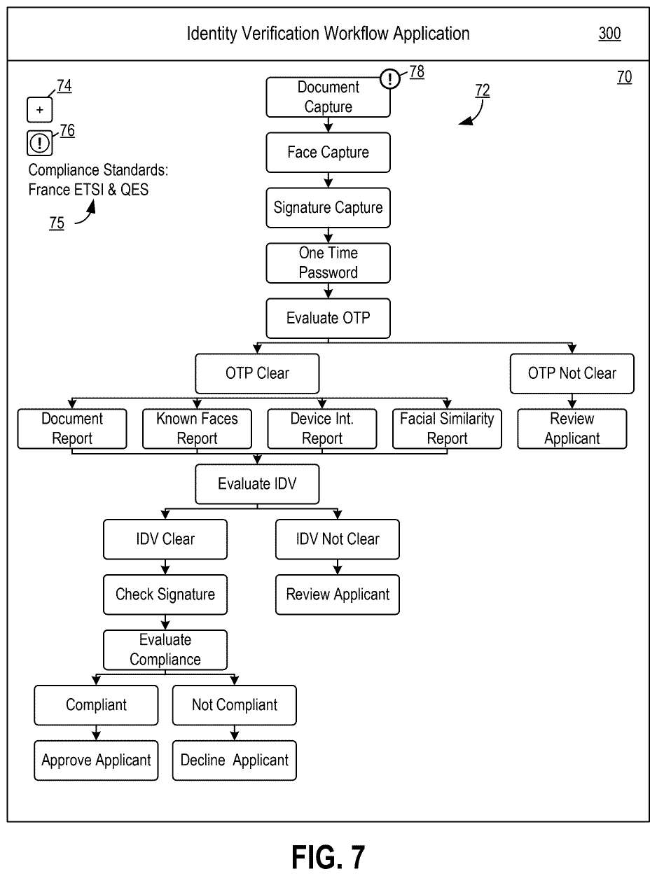

FIG. 7 illustrates a fourth example workflow interface 70 in which the user has added a Device Intelligence Report task to the workflow 72. Because the workflow 72 is revalued when the new task is added to the workflow 72, the status of the workflow 72—as indicated by the workflow status indicator 76 and the task status indicators 78—may be updated to reflect an updated state of the workflow 72. In the illustrated example, the workflow 72 still includes issues that affect compliance; however, the issue with the Evaluate Compliance task has been addressed, so a task status indicator 78 is no longer presented on the Evaluate Compliance task.

As described above, in this example, the Document Capture task may include an issue affecting the compliance of the workflow 72 due to document types supported by the task. Like with the Evaluate Compliance task, the user may select the Document Capture task, and the workflow interface 70 may present an task configuration interface 82 through which the user can modify the Document Capture task.

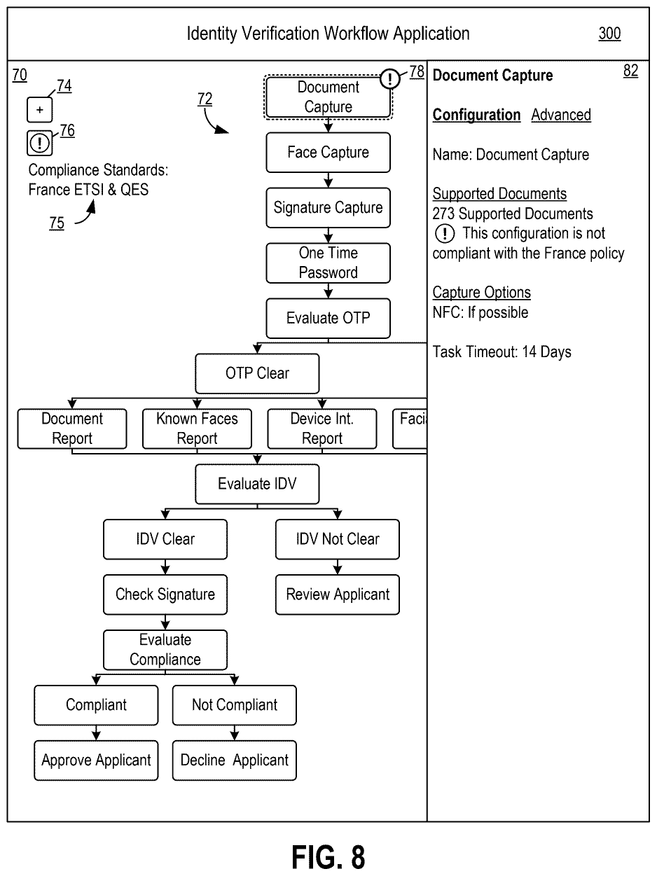

FIG. 8 illustrates a fifth example workflow interface 70 in which a task configuration interface 82 is presented through which the user can modify the Document Capture task. In the illustrated example, the task configuration interface 82 includes options for the user to modify a configuration of the task and other settings of the task.

In this example, a configuration option for the Document Capture task includes selected supported documents. As shown in FIG. 8, in this example, 273 documents are supported in the configuration of the Document Capture task. As described above, one or more of the supported documents may conflict with the selected compliance standards, causing an error with the Document Capture task. To make the Document Capture task compliant with the selected compliance standards, the user may modify which documents are supported.

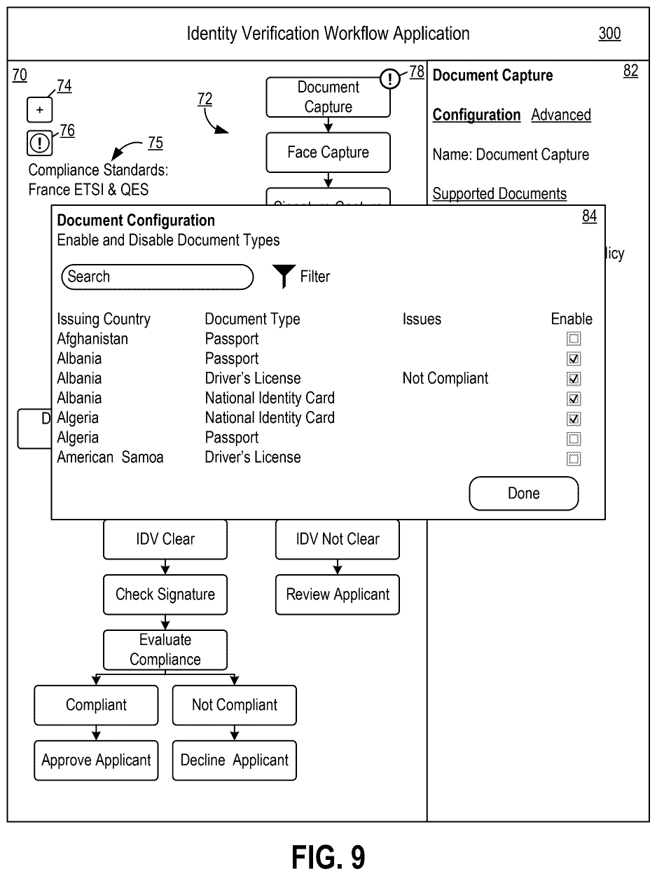

The user may select to modify the documents supported by the Document Capture task—e.g., by clicking on the supported documents. FIG. 9 illustrates a sixth example workflow interface 70 in which the workflow interface 70 includes a document configuration interface 84. The user may interact with the document configuration interface 84 to select which documents are supported by the Document Capture task.

In the illustrated example, the document configuration interface 84 includes a list of documents with options to enable the documents for the corresponding Document Capture task. In embodiments, the documents are identified by an issuing country and a document type (e.g., an Afghanistan passport). In an example, the document configuration interface 84 includes an option to search for specific documents and an option to filter the list of documents.

In examples, the document configuration interface 84 includes issues between enabled documents and the selected compliance standards. As shown in the illustrated example, capturing an Albanian driver's license may not be compliant with the selected compliance standards. For example, the selected compliance standards may require a color photograph to be included on the captured document, and a driver's license issued in Albania may include a black and white photograph, making the document noncompliant with the compliance standards.

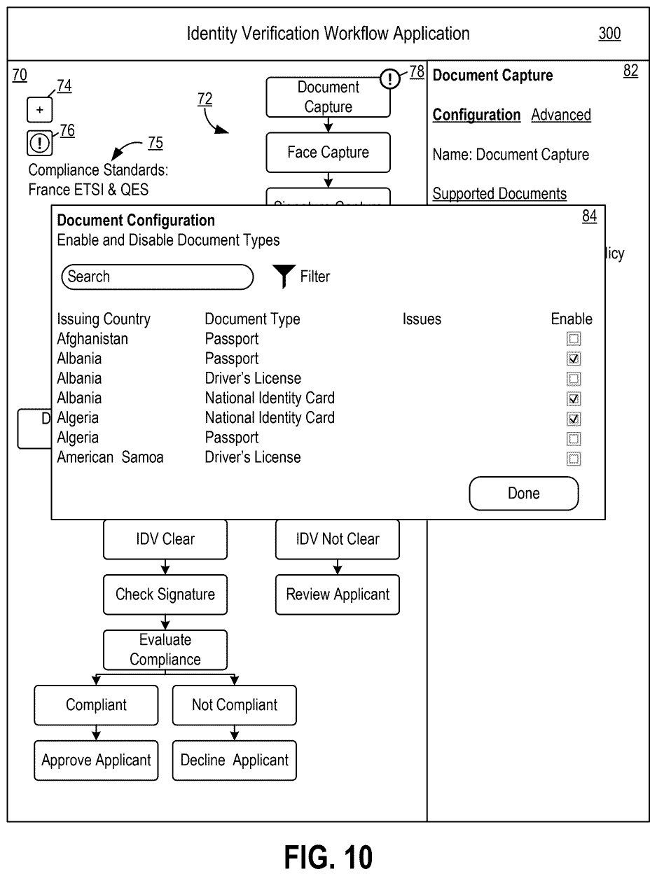

The user may select to disable noncompliant documents in the document configuration interface 84. FIG. 10 illustrates a seventh example workflow interface 70 in which the user has selected to disable all noncompliant document types. As shown in FIG. 10, when a noncompliant document (e.g., a driver's license from Albania) is not enabled, the document configuration interface 84 may update to remove the issues previously presented when the compliant document was selected.

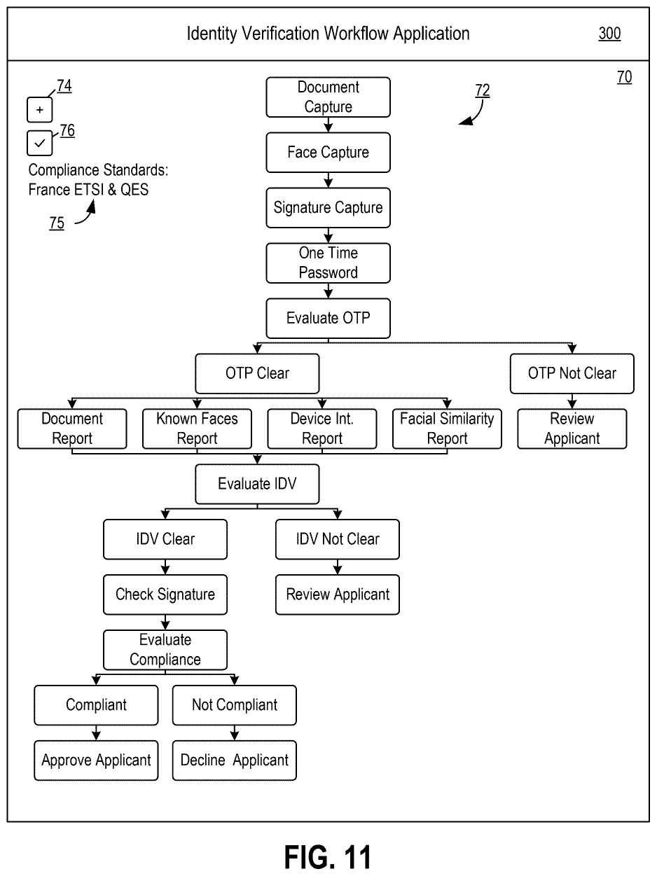

FIG. 11 illustrates an eighth example workflow interface 70. In the example illustrated in FIG. 11, the workflow 72 may be both valid and compliant. Accordingly, in the illustrated example, the workflow status indicator 76 may indicate that the workflow 72 is valid and compliant. Similarly, because the workflow is valid and compliant, the workflow interface 70 may not include task status indicators 78 as there are no errors with the tasks of the workflow 72. In example embodiments, when the workflow 72 is valid and compliant, the user may activate the workflow 72, enabling an authentication server to execute the workflow 72.

While the above examples describe a few examples of compliance issues that may be detected as a user works on a workflow 72, the scope of the present disclosure is not limited thereto. In alternative examples, additional or alternative compliance issues may be detected with various tasks of a workflow 72, including other identity verification tasks not included in the above examples. Similarly, the disclosure is not limited to verifying that a workflow 72 is compliant with the compliance standards described above. In alternative examples, additional or alternative compliance standards may be used to evaluate a workflow 72.

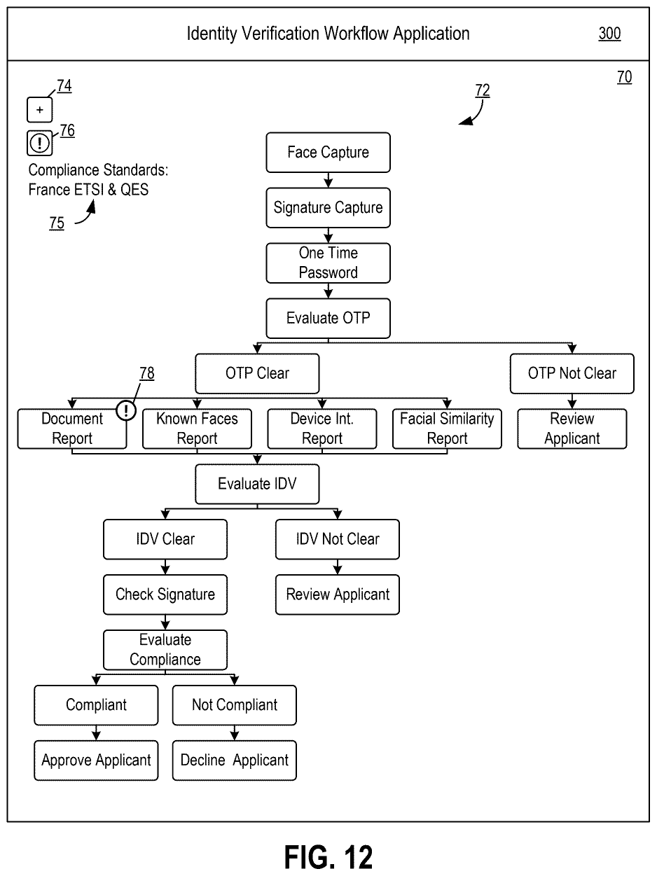

Additionally, while the above examples describe determining that a workflow 72 is not compliant and presenting indicators in the workflow interface 70 to indicate noncompliance, the workflow may also be checked for validity, and issues with validity may be indicated in the workflow interface 70 as well. FIG. 12 illustrates a ninth example workflow interface 70 in which the workflow 72 is invalid. Like with noncompliant workflows 72, the workflow status indicator 76 may indicate that there are issues with the workflow 72, and task status indicators 78 may indicate which tasks have issues.

In the illustrated example, the workflow 72 is invalid because the workflow 72 includes a task to execute a document report, but the workflow 72 does not include a task to capture a document. Accordingly, the Document Report task is missing a required input, making the workflow 72 invalid. To correct the error, the user may select the option 74 to add a task and add a Document Capture task to the workflow 72.

While the above example describes one example of an invalid workflow 72, in alternative examples additional or alternative errors may cause the workflow 72 to be invalid. In embodiments, any task that is missing a required input may cause the workflow 72 to be invalid.

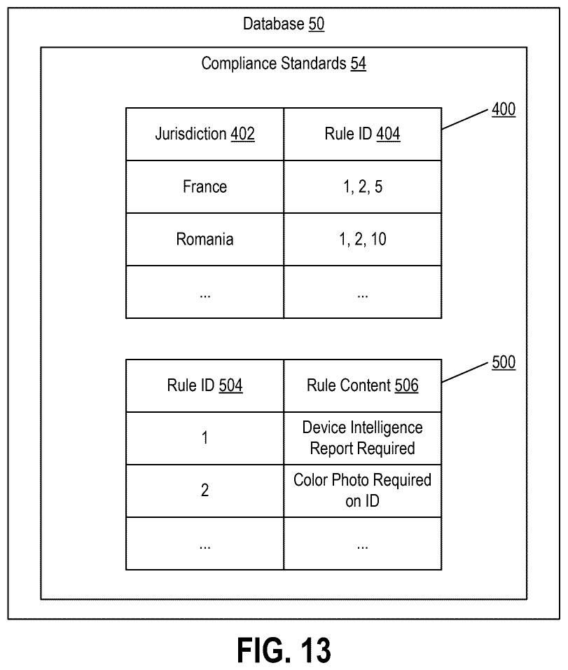

Referring to FIG. 13, example compliance standards 54 stored in a database 50 are shown. As described above, compliance standards 54 may be selected by a user to determine whether a workflow is compliant with the compliance standards 54. In examples, a user may select a country or other jurisdiction in which the workflow is to be executed, and the compliance standards 54 that apply in the jurisdiction may automatically be determined.

In the illustrated example, the compliance standards 54 are maintained in the database 50 as two tables: a jurisdiction table 400 and a rules table 500. While tables are described in this example, in alternative embodiments additional or alternative data structures may be used to store data associated with compliance standards 54 in the database 50. In an example, the jurisdiction table 400 may map a jurisdiction 402 to one or more rules 404 that apply in the jurisdiction 402 based on compliance standards adopted within the jurisdiction 402. In an example the rules 404 listed in the jurisdiction table 400 may be identifiers used to identify applicable rules in the rules table 500. In the illustrated example, the rules table 500 maps rule identifiers 504 to rule content 506. Using the jurisdiction table 400 and the rules table 500, the applicable rules for jurisdiction 402 can be determined.

In an example, because the jurisdictions 402 are mapped to rule identifiers 404, a workflow can be evaluated against compliance standards 54 for multiple jurisdictions 402 without redundancies. For example, in the illustrated embodiment, rules 1, 2, and 5 apply in France, and rules 1, 2, and 10 apply in Romania. In an example in which the user selects for a workflow to be evaluated for both French and Romanian compliance standards 54, the rules that apply can be analyzed to determine if rules are redundant. In this case, because rules 1 and 2 apply in both France and Romania, to check for compliance in France and Romania, rules 1, 2, 5, and 10 are checked. In contrast, if jurisdictions were checked independently, the workflow would be evaluated against rules 1 and 2 multiple times—i.e., when checking if the workflow is compliant in France, rules 1, 2, and 5 would be checked, and then when checking if the workflow is compliant in Romania, rules 1, 2, and 10 would be checked.

In another example, a workflow may include multiple branches in which each branch is associated with a different jurisdiction. For example, a first branch may be associated with France and a second branch may be associated with Romania. In this example, a rule may need to be checked twice (e.g., rules 1 and 2 would need to be checked for both the France branch and the Romania branch). However, because the rules that need to be checked for each jurisdiction associated with the workflow can be determined, redundancies when downloading the rules from the database 50 may be eliminated. For example, rather than download the rules for France and Romania separately (which would lead to rules 1 and 2 being downloaded multiple times), each of the applicable rules can be identified before downloading from the database 50, and then the required set of rules can be downloaded.

While FIG. 13 illustrates an example of how compliance standards 54 may be maintained in a database 50, in alternative embodiments, the compliance standards 54 may be maintained in a different configuration. In an embodiment, task definitions stored in the database 50 may be associated with applicable compliance standards 54. For example, a task configured to verify compliance of the workflow at runtime may define the rules against which compliance of the workflow is verified. Because these rules are defined in the task, compliance of the workflow at design time (i.e., as a user is building the workflow) may be verified by evaluating the workflow against the defined rules.

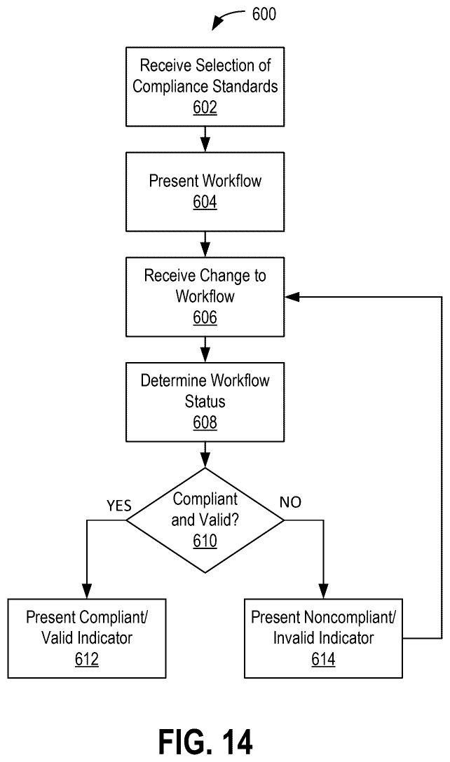

FIG. 14 illustrates a flowchart of an example method 600 for managing identity verification workflow compliance. In the illustrated example, the method 600 includes operations 602, 604, 606, 608, 610, 612, 614. In an example the method 600 may be performed by the system 200 described above in connection with FIG. 2.

The operation 602 includes receiving a selection of compliance standards. In examples, a user may select compliance standards against which a workflow will be evaluated. In examples, the compliance standards may be associated with one or more workflow rules. In some embodiments, the user may select one or more jurisdictions, and the compliance standards that apply in the selected jurisdictions are selected. In an example, the selection of compliance standards is received in a new workflow interface or a workflow interface presented on a computing device.

In another example, the compliance standards are selected based on the user adding a workflow compliance task to the workflow. For example, the workflow compliance task may, during execution of the workflow, verify that the execution of the workflow is compliant with one or more compliance standards. In this example, the workflow compliance task may be associated with the one or more compliance standards, so the compliance standards against which the workflow may be evaluated while the user is building the workflow may be determined based on the addition of the workflow compliance task.

The operation 604 includes presenting a workflow. As described above, the workflow may include one or more tasks that are executed during the workflow. In an example, the workflow may include an identity verification workflow. In an example, the workflow may be presented in a workflow interface on a computing device.

The operation 606 includes receiving a workflow edit input defining a change to the workflow. For example, the change to the workflow may include the addition of a task, the removal of a task, or a modification of a task. In some examples, the change workflow edit input is received at a workflow interface on a computing device. For example, a user may change the workflow in a drag-and-drop manner to modify the position and connections of tasks within the workflow. Further, in some examples, a user may select a task of the workflow to change a configuration or other settings of the task.

The operation 608 includes determining a status of the workflow. In an example, the status of the workflow is determined each time a change is made to the workflow. In embodiments, the status of the workflow may include whether the workflow is compliant with the selected compliance standards. For example, the workflow may be compliant with the selected compliance standards if the workflow satisfies the workflow rules associated with the selected compliance standards. In some embodiments, the status of the workflow may additionally or alternatively include a validity of the workflow. In examples, a workflow is valid if for each task in the workflow, the required inputs and configurations are provided. In another example, to be valid, each branch of the workflow may be required to end with a node associated with a validation outcome. In an embodiment, a workflow management engine may determine the status of the workflow. For example, a compliance manager may determine whether the workflow is compliant with the selected compliance standards, and a workflow validator may determine if the workflow is valid.

The operation 610 includes determining if the workflow is compliant and valid. If the workflow is compliant and valid, the method 600 progresses to the operation 612. The operation 612 includes presenting an indicator that the workflow is compliant and valid. In examples, the indicator is presented in a workflow interface on a computing device. When the workflow is valid and compliant, a user may be able to activate the workflow.

If the workflow is determined to be either noncompliant or invalid, the method 600 proceeds to the operation 614. The operation 614 includes presenting an indicator that the workflow is not compliant or not valid. In an example, the indicator is presented in a workflow interface on a computing device. In some examples, the indicator may include one or more task indicators. The task indicators may indicate which tasks in the workflow have issues that make the workflow noncompliant or invalid.

In some embodiments, if the workflow is determined to be noncompliant or invalid, the method 600 may repeat the operations 606 608, 610, 614 until the workflow is determined to be valid and compliant. In examples, a workflow that is invalid or noncompliant cannot be activated, so a user may continue to modify an invalid or noncompliant workflow until it is valid and compliant. As described above, each time the workflow is modified, the workflow may be evaluated to determine if the workflow is valid and compliant.

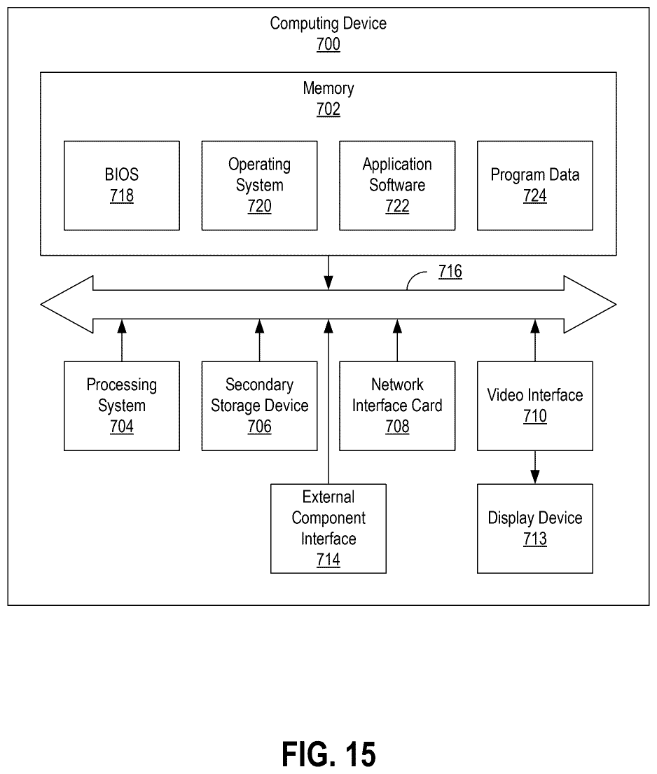

FIG. 15 illustrates an example computing device 700 on which aspects of the present disclosure may be implemented. The computing device 700 can be used, for example, to implement computing devices such as the computing device 30, the authentication server 20, or any other computing device usable as described above in connection with FIGS. 1 and 2.

In the example of FIG. 15, the computing device 700 includes a memory 702, a processing system 704, a secondary storage device 706, a network interface card 708, a video interface 710, a display unit 713, an external component interface 714, and a communication medium 716. The memory 702 includes one or more computer storage media capable of storing data and/or instructions. In different embodiments, the memory 702 is implemented in different ways. For example, the memory 702 can be implemented using various types of computer storage media, and generally includes at least some tangible media. In some embodiments, the memory 702 is implemented using entirely non-transitory media.

The processing system 704 includes one or more processing units, or programmable circuits. A processing unit is a physical device or article of manufacture comprising one or more integrated circuits that selectively execute software instructions. In various embodiments, the processing system 704 is implemented in various ways. For example, the processing system 704 can be implemented as one or more physical or logical processing cores. In another example, the processing system 704 can include one or more separate microprocessors. In yet another example embodiment, the processing system 704 can include an application-specific integrated circuit (ASIC) that provides specific functionality. In yet another example, the processing system 704 provides specific functionality by using an ASIC and by executing computer-executable instructions.

The secondary storage device 706 includes one or more computer storage media. The secondary storage device 706 stores data and software instructions not directly accessible by the processing system 704. In other words, the processing system 704 performs an I/O operation to retrieve data and/or software instructions from the secondary storage device 706. In various embodiments, the secondary storage device 706 includes various types of computer storage media. For example, the secondary storage device 706 can include one or more magnetic disks, magnetic tape drives, optical discs, solid-state memory devices, and/or other types of tangible computer storage media.

The network interface card 708 enables the computing device 700 to send data to and receive data from a communication network. In different embodiments, the network interface card 708 is implemented in different ways. For example, the network interface card 708 can be implemented as an Ethernet interface, a fiber optic network interface, a wireless network interface (e.g., WiFi, WiMax, Bluetooth, etc.), or another type of network interface.

In optional embodiments where included in the computing device 700, the video interface 710 enables the computing device 700 to output video information to the display unit 713. The display unit 713 can be various types of devices for displaying video information, such as an LCD display panel, a plasma screen display panel, a touch-sensitive display panel, an LED or OLED screen, a cathode-ray tube display, or a projector. The video interface 710 can communicate with the display unit 713 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 714 enables the computing device 700 to communicate with external devices. For example, the external component interface 714 can be a USB interface and/or another type of interface that enables the computing device 700 to communicate with external devices or peripheral devices integrated within the same housing (e.g., in the case of mobile devices). In various embodiments, the external component interface 714 enables the computing device 700 to communicate with various external components, such as external storage devices, input devices, speakers, modems, media player docks, other computing devices, scanners, digital cameras, and fingerprint readers.

The communication medium 716 facilitates communication among the hardware components of the computing device 700. The communication medium 716 facilitates communication among the memory 702, the processing system 704, the secondary storage device 706, the network interface card 708, the video interface 710, and the external component interface 714. The communication medium 716 can be implemented in various ways. For example, the communication medium 716 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. The memory 702 stores a Basic Input/Output System (BIOS) 718 and an operating system 720. The BIOS 718 includes a set of computer-executable instructions that, when executed by the processing system 704, cause the computing device 700 to boot up. The operating system 720 includes a set of computer-executable instructions that, when executed by the processing system 704, cause the computing device 700 to provide an operating system that coordinates the activities and sharing of resources of the computing device 700. Furthermore, the memory 702 stores application software 722. The application software 722 includes computer-executable instructions, that when executed by the processing system 704, cause the computing device 700 to provide one or more applications. In an example, the memory 702 stores application software 722 for an identity verification workflow application. The memory 702 also stores program data 724. The program data 724 is data used by programs that execute on the computing device 700.

Although particular features are discussed herein as included within an electronic computing device 700, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 700 of FIG. 15, the computer-readable instructions are stored on devices that include non-transitory media. In particular embodiments, the computer-readable instructions are stored on entirely non-transitory media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A method for managing identity verification workflow compliance, the method comprising:
receiving a selection of one or more compliance standards, wherein the one or more compliance standards are associated with a workflow rule;
presenting, at a workflow interface, a workflow, wherein the workflow includes one or more tasks performed during execution of the workflow;
receiving, at the workflow interface, a workflow edit input defining a change to the workflow;
in response to receiving the workflow edit input, determining a status of the workflow, wherein the status of the workflow includes a compliance of the workflow with the workflow rule; and
presenting, at the workflow interface, a workflow status indicator based on the determined status of the workflow.

2. The method of claim 1, further comprising:
based on a determination that the workflow is not compliant with the workflow rule, preventing activation of the workflow.

3. The method of claim 1, wherein the status of the workflow further includes a validity of the workflow.

4. The method of claim 3, further comprising:
based on a determination that the workflow is not valid, preventing activation of the workflow.

5. The method of claim 1, wherein receiving the selection of the one or more compliance standards comprises:
receiving a selection of a workflow compliance task to be added to the workflow, wherein the workflow compliance task is associated with the one or more compliance standards.

6. The method of claim 1, wherein the workflow is selected from a list of one or more preconfigured template workflows.

7. The method of claim 1, further comprising:
presenting, at the workflow interface, a task status indicator based on the determined status of the workflow, wherein the task status indicator is associated with a noncompliant task of the workflow.

8. A system for managing identity verification workflow compliance, the system comprising:
one or more processors; and
one or more computer-readable storage devices storing data instructions that, when executed by the one or more processors, cause the system to:
receive a selection of one or more compliance standards, wherein the one or more compliance standards are associated with a workflow rule;
present, at a workflow interface, a workflow, wherein the workflow includes one or more tasks performed during execution of the workflow;
receive, at the workflow interface, a workflow edit input defining a change to the workflow;
in response to receiving the workflow edit input, determine a status of the workflow, wherein the status of the workflow includes a compliance of the workflow with the workflow rule; and
present, at the workflow interface, a workflow status indicator based on the determined status of the workflow.

9. The system of claim 8, wherein execution of the data instructions further causes the system to:
based on a determination that the workflow is not compliant with the workflow rule, prevent activation of the workflow.

10. The system of claim 8, wherein the status of the workflow further includes a validity of the workflow.

11. The system of claim 10, wherein execution of the data instructions further causes the system to:
based on a determination that the workflow is not valid, prevent activation of the workflow.

12. The system of claim 8, wherein to receive the selection of one or more compliance standards includes to:
receive a selection of one or more jurisdictions in which the workflow is configured to execute; and
determine the one or more compliance standards based on the one or more selected jurisdictions, wherein the one or more compliance standards apply in at least one of the one or more selected jurisdictions.

13. The system of claim 8, wherein the workflow is selected from a list of one or more preconfigured template workflows.

14. The system of claim 8, wherein execution of the data instructions further causes the system to:
present, at the workflow interface, a task status indicator based on the determined status of the workflow, wherein the task status indicator is associated with a noncompliant task of the workflow.

15. A non-transitory computer-readable medium having stored thereon data instructions that, when executed by one or more processors, cause the one or more processors to:
receive a selection of one or more compliance standards, wherein the one or more compliance standards are associated with a workflow rule;
present, at a workflow interface, a workflow, wherein the workflow includes one or more tasks performed during execution of the workflow;
receive, at the workflow interface, a workflow edit input defining a change to the workflow;
in response to receiving the workflow edit input, determine a status of the workflow, wherein the status of the workflow includes a compliance of the workflow with the workflow rule; and
present, at the workflow interface, a workflow status indicator based on the determined status of the workflow.

16. The computer-readable medium of claim 15, wherein execution of the data instructions further causes the one or more processors to:
based on a determination that the workflow is not compliant with the workflow rule, prevent activation of the workflow.

17. The computer-readable medium of claim 15, wherein the status of the workflow further includes a validity of the workflow.

18. The computer-readable medium of claim 17, wherein execution of the data instructions further causes the one or more processors to:
based on a determination that the workflow is not valid, prevent activation of the workflow.

19. The computer-readable medium of claim 15, wherein to receive the selection of one or more compliance standards includes to:
receive a selection of one or more jurisdictions in which the workflow is configured to execute; and
determine the one or more compliance standards based on the one or more selected jurisdictions, wherein the one or more compliance standards apply in at least one of the one or more selected jurisdictions.

20. The computer-readable medium of claim 15, wherein the workflow is selected from a list of one or more preconfigured template workflows.
